(19) United States
(12) Patent Application Publication
(10) Pub. No.: US 2024/0392414 A1
(43) Pub. Date: Nov. 28, 2024

(54) METHODS AND APPARATUS FOR PRODUCTION OF RARE EARTH ELEMENTS FROM COAL AND CLAY ORES

(71) Applicant: CARBON HOLDINGS INTELLECTUAL PROPERTIES, LLC, Ranchester, WY (US)

(72) Inventors: Charles Agee Atkins, Sheridan, WY (US); Garrett W. Lindemann, Buffalo, WY (US); Donald W. Collins, Santa Clarita, CA (US); Charles Hill, Sheridan, WY (US); Alex Moyes, Chester, VA (US)

(73) Assignee: CARBON HOLDINGS INTELLECTUAL PROPERTIES, LLC, Ranchester, WY (US)

(21) Appl. No.: 18/675,598

(22) Filed: May 28, 2024

Related U.S. Application Data
(60) Provisional application No. 63/504,414, filed on May 25, 2023.

(51) Int. Cl. C22B 59/00; B01J 20/20; B01J 20/28; B01J 20/32; B01J 20/34; C22B 4/04; C22B 4/08; D01F 9/15

(52) U.S. Cl. CPC C22B 59/00; B01J 20/20; B01J 20/28023; B01J 20/28042; B01J 20/3204; B01J 20/3274; B01J 20/3293; B01J 20/3416; B01J 20/3441; C22B 4/04; C22B 4/08; D01F 9/15

(57) ABSTRACT

A method of separating a rare earth element from coal and clay ores includes subjecting a raw coal to a liquefaction process to form a pitch or a pitch resin and filtering the pitch or pitch resin to capture the rare earth element. The method further includes refining the pitch or pitch resin to produce a mesophase pitch. The method also includes subjecting the mesophase pitch or pitch resin to a low-crystallinity spinning process to form a carbon fiber.

### CROSS-REFERENCE TO RELATED APPLICATION

This application claims priority to U.S. Provisional Patent Application No. 63/504,414 filed May 25, 2023, and entitled “RARE EARTH ELEMENTS FROM COAL AND CLAY ORES,” the disclosure of which is hereby incorporated by reference in its entirety.

### FIELD

The described embodiments relate generally to carbon based processing methods. More particularly, the present embodiments relate to systems and methods for processing hydrocarbon coal to make advanced carbon materials and extracting rare earth elements from the coal deposits.

### BACKGROUND

Coal has been mined and used for a variety of purposes for thousands of years. Since the industrial revolution, the primary use for coal has been to generate heat and energy to power homes, industry, and transportation. Coal initially found widespread use as a transportation fuel for trains during the industrial revolution, but the advent of cars and the discovery of large petroleum deposits near the turn of the twentieth century precipitated a shift towards the primacy of liquid, petroleum-based fuels for transportation.

Research on coal continued, however, and the basic chemistry of coal was well understood by at least the early twentieth century. Although significant research has been conducted on coal for more than a century, this extensive prior work has overwhelmingly been focused on the development of transportation fuels. The use of coal to produce other materials of greater industrial relevance has yet to be fully explored. For example, Coal and coal preparation products contain rare earth elements (REEs), which are a group of 17 elements including dysprosium, neodymium, europium, terbium, and thulium.

REEs are critical in the manufacturing of high-demand products like batteries and solar panels. They are increasingly required for a range of modern applications in defense and renewable energy technologies, as well as commercial products, primarily as magnets, batteries, and catalysts.

### SUMMARY

A method of separating a rare earth element from coal and clay ores includes subjecting a raw coal to a liquefaction process to form a pitch or a pitch resin and filtering the pitch or pitch resin to capture the rare earth element. In some examples, the method further includes refining the pitch or pitch resin to produce a mesophase pitch and subjecting the mesophase pitch or pitch resin to a low-crystallinity spinning process to form a carbon fiber. In some examples, the rare earth element can be defined to include at least one of gallium, germanium, cerium, lanthanum, neodymium, praseodymium, scandium, yttrium, dysprosium, terbium, samarium, ytterbium, europium, promethium, gadolinium, holmium, lutetium, thulium, or erbium. In an example, the pitch or pitch resin can include an isotropic pitch.

In at least one example, filtering the pitch or a pitch resin can include removing impurities and water to physically sort and detect the rare earth element. In an example, the method can further include rehydrating the pitch or pitch resin to between about 6% and about 8% moisture. In some examples, the method can further include sorting the rare earth element as either a heavy rare earth element or a light rare earth element.

In some examples, the method of separating a rare earth element from coal and clay ores includes modifying the carbon fiber to bind or electrostatically interact with a rare earth element. In an example, modifying the carbon fiber to bind or electrostatically interact with the rare earth element includes attaching a mineral binding protein or a lanthanide binding protein to the carbon fiber. In other examples, modifying the carbon fiber to bind or electrostatically interact with the rare earth element can include increasing a negative charge of the carbon fiber to increase an electrostatic interaction with the rare earth element.

In at least one example, a method of extracting a rare earth element from a coal deposit utilizing an electrothermal swing adsorption system includes subjecting a coal deposit comprising coal and clay ores to a liquefaction process to form a pitch and feeding the pitch into a chamber of an electrothermal swing adsorption apparatus. In an example, the method further includes adsorbing the rare earth element with a carbon monolith in the chamber and outputting the pitch from the chamber of the electrothermal swing adsorption apparatus.

In an example, the method of extracting a rare earth element from a coal deposit utilizing an electrothermal swing adsorption system can include applying an electrical current to the carbon monolith in the chamber to raise a temperature of the carbon monolith to desorb the rare earth element from the carbon monolith. In some examples, adsorbing the rare earth element with a carbon monolith in the chamber can include moving the carbon monolith through the pitch. In an example, the carbon monolith can include a coal-based activated carbon fiber. In an example, the liquefaction process can include crushing the coal deposit and suspending coal solids in a fluid having between about 6% and about 8% moisture. In some examples, the crushed coal deposit can include a particle diameter of between about 0.5 microns and about 50 microns.

In at least one example, a system to extract a rare earth element from a coal deposit includes a first chamber comprising at least one carbon monolith and a second chamber comprising at least one carbon monolith. In an example, the electrothermal swing adsorption apparatus is configured to receive a feed of a coal-based pitch with at least one rare earth element therein and each of the carbon monolith of the electrothermal swing adsorption apparatus includes coal-based activated carbon fibers configured to capture the rare earth element.

In an example, the at least one carbon monolith of the first chamber captures the rare earth element and the at least one carbon monolith of the second chamber desorbs the rare earth element simultaneously as the at least one carbon monolith of the first chamber releases the rare earth element. In an example, the first chamber and the second chamber operate in a cyclical fashion to perform continuous capture and release of rare earth elements such that capture occurs in one of the first chamber and the second chamber while release occurs in the other of the first chamber and the second chamber. In some examples, ach carbon monolith is functionalized to adsorb a specific rare earth element. In some examples, the coal-based activated carbon fibers are melt-blown from an isotropic pitch.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 illustrates the process flow of a rare earth element from coal and clay ores and forming a carbon fiber, according to an embodiment.

FIG. 2 illustrates a system for separating a rare earth element from coal and clay ores, according to an embodiment.

FIG. 3 illustrates a schematic of an electrothermal swing adsorption system with a plurality of electrothermal swing adsorption apparatuses according to one embodiment of the present disclosure.

FIG. 4A illustrates a schematic of an electrothermal swing adsorption apparatus in a first configuration according to one embodiment of the present disclosure.

FIG. 4B illustrates a schematic of the electrothermal swing adsorption apparatus of FIG. 5 in a second configuration.

FIG. 5 is a flow chart of a method of extracting a rare earth element from a coal deposit utilizing an electrothermal swing adsorption system.

Throughout the drawings, identical reference numbers designate similar, but not necessarily identical, elements.

### DETAILED DESCRIPTION

As described below, rare earth elements and advanced carbon materials, such as carbon fibers can be produced from raw, mined coal. The present description provides examples, and is not limiting of the scope, applicability, or configuration set forth in the claims. Thus, it will be understood that changes can be made in the function and arrangement of elements discussed without departing from the spirit and scope of the disclosure, and various embodiments can omit, substitute, or add other procedures or components, as appropriate. For instance, methods described can be performed in an order different from that described, and various steps can be added, omitted, or combined. Also, features described with respect to some embodiments can be combined in other embodiments.

Rare earths are a group of elements, like neodymium, praseodymium and scandium. Rare earths are used in a wide array of applications. In this disclosure, rare earth elements can include the fifteen lanthanides on the periodic table plus scandium and yttrium and can also refer to gallium and germanium herein. Rare-earth elements (REE) are necessary components of several products across a wide range of applications, especially high-tech consumer products, such as cellular telephones, computer hard drives, electric and hybrid vehicles, and flat-screen monitors and televisions. Significant defense applications include electronic displays, guidance systems, lasers, and radar and sonar systems. Although the amount of REE used in a product may not be a significant part of that product by weight, value, or volume, the REE can be necessary for the device to function.

On average, the REE content in coal can be about 68 ppm, and 404 ppm in coal ash. The REE can be recovered and upgraded from the coal. Direct coal liquefaction (DCL) involves contacting coal directly with a catalyst at elevated temperatures and pressures with added hydrogen (H₂), in the presence of a solvent to form a raw liquid product which can be filtered or processed to extract the REE and further refined into products such as liquid fuels. DCL is termed “direct” because the coal is transformed into liquid without first being gasified to form syngas (which can then in turn be transformed into liquid products). The latter two-step approach, i.e. the coal-to-syngas-to-liquids route is termed indirect coal liquefaction (ICL). Therefore, the DCL process is, in principle, the simpler and more efficient of the two processes. DCL can, however, require an external source of H₂, which may have to be provided by gasifying additional coal feed, biomass, and/or the heavy residue produced from the DCL reactor. The DCL process results in a relatively wide hydrocarbon product range consisting of a variety of molecular weights and forms, with aromatics dominating. Accordingly, the product can require substantial upgrading to yield desirable products.

The DCL process can involve adding hydrogen (hydrogenation) to the coal, breaking down the organic structure of the coal into soluble products. The reaction in DCL is carried out at elevated temperature and pressure (e.g., 750° F. to 850° F. (about 399° C. to about 454° C.) and 1,000 to 2,500 psia) in the presence of a solvent. The solvent is used to facilitate coal extraction and the addition of hydrogen. The solubilized products, including mainly aromatic compounds, may then be upgraded by conventional petroleum refining techniques, such as hydrotreating, to meet final liquid product specifications.

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The systems and methods herein can include liquefying a coal to form a coal tar pitch and removing REEs from the pitch. The coal tar pitch can be thermally treated to a liquid crystal phase exhibiting anisotropic spheres of mesophase and further spun to form carbon fibers. In some examples, the pitch can be fed into an electrothermal swing adsorption apparatus wherein the REE can be absorbed with a carbon monolith.

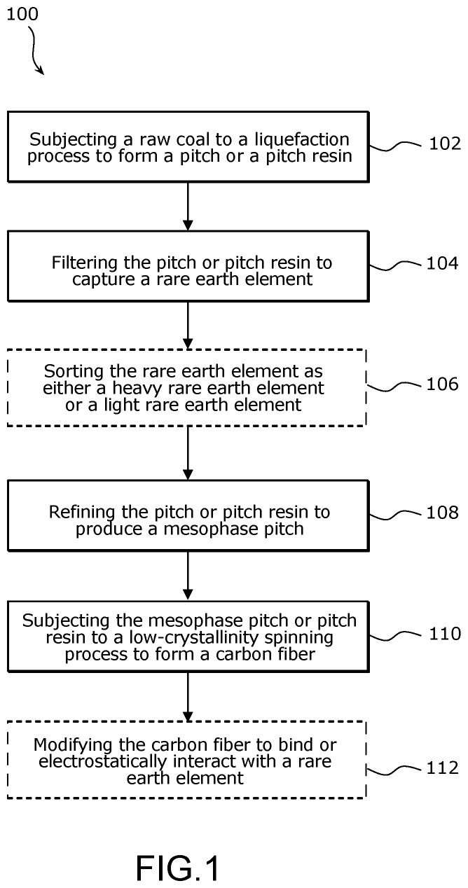

According to some embodiments, and as illustrated in FIG. 1, a method 100 of separating a rare earth element from coal and clay ores may include an act 102 of subjecting a raw coal to a liquefaction process to form a pitch or a pitch resin, an act 104 of filtering the pitch or pitch resin to capture the rare earth element, an act 106 of sorting the rare earth element as either a heavy rare earth element or a light rare earth element, an act 108 of refining the pitch or pitch resin to produce a mesophase pitch, an act 110 of subjecting the mesophase pitch or pitch resin to a low-crystallinity spinning process to form a carbon fiber, and an act 112 of modifying the carbon fiber to bind or electrostatically interact with a rare earth element. In some examples, the filtering process can increase the concentration of the REE in the pitch from about 400 ppm to about 8000 ppm.

In some embodiments the act 102 of subjecting a raw coal to a liquefaction process to form a pitch or a pitch resin can include contacting an amount of coal directly with a catalyst in the presence of a solvent, exerting a predetermined pressure of about 1000 pounds per square inch absolute (psia) or less on the amount of coal and the solvent, heating the amount of coal and the solvent to a predetermined temperature of about 380° C. or less, and liquefying at least some of the amount of coal to form a coal tar pitch. In some examples, the coal can comprise anthracite coal and/or coal extracted from Wyoming's Powder River Basin. The catalyst may include any catalyst described herein or known in the art, and the solvent may include any solvent described herein or known in the art. In some examples, a solvent can include one or more of N-Methyl-2-pyrrolidone (NMP), quinoline, fluorinert FC-71, silicone oils, phthalates such as dioctyl phthalate, syltherm 800, or any other suitable solvent or carrier. In some examples, the catalyst can be, but is on no way limited to a Lewis acid catalyst.

In many examples, the act 102 can include pressurizing the coal to a predetermined pressure (e.g., about 975 psia or less, about 950 psia or less, about 925 psia or less, about 900 psia or less, about 875 psia or less, about 850 psia or less, about 825 psia or less, about 800 psia or less, about 775 psia or less, about 750 psia or less, about 725 psia or less, about 700 psia or less, about 675 psia or less, about 650 psia or less, about 625 psia or less, about 600 psia or less, about 575 psia or less, about 550 psia or less, about 525 psia or less, about 500 psia or less, about 475 psia or less, about 450 psia or less, about 425 psia or less, about 400 psia or less, about 375 psia or less, about 350 psia or less, about 350 psia to about 450 psia, about 400 psia to about 500 psia, about 450 pisa to about 550 psia, about 500 psia to about 600 psia, about 550 psia to about 650 psia, about 600 psia to about 700 psia, about 650 psia to about 750 psia, about 700 psia to about 800 psia, about 750 psia to about 850 psia, about 800 psia to about 900 psia, about 850 psia to about 950 psia) while simultaneously heating the coal to a predetermined temperature (e.g., about 380° C. or less, about 375° C. or less, about 370° C. or less, about 365° C. or less, about 360° C. or less, about 355° C. or less, about 350° C. or less, about 325° C. or less, about 320° C. or less, about 315° C. or less, about 310° C. or less, about 305° C. or less, about 300° C. or less, about 295° C. or less, about 290° C. or less, about 285° C. or less, about 280° C. or less, about 275° C. or less, about 270° C. or less, about 265° C. or less, about 260° C. or less, about 255° C. or less, 250° C. or less), and while contacting the coal directly with the catalyst in the presence of the solvent and the added hydrogen. As noted above, the raw coal can include an amount of REEs therein. In some examples, the coal and/or clay ores can include about 400 ppm of a REE.

Act 104 of the method 100 of separating a rare earth element from coal and clay ores includes filtering the pitch or pitch resin to capture the rare earth element. In some embodiments, the filter can include a carbon fiber filter, however other filter types can be included. In some examples, the filter can include a nylon filter, a fabric filter, membrane systems, mechanical collectors, wet scrubbers, and electrostatic precipitators. In some examples the filter can provide filtrate quality of less than 0.3-0.5 parts per million (ppm) for particles as small as 0.5-1 μm. In some examples, filter can be less than 100 microns. In other embodiments, the filter can be less than 80 microns. For example, the REE may exhibit a diameter that is about 5 μm or less, about 10 μm or less, about 20 μm or less, about 30 μm or less, about 50 μm or less, about 60 μm or less, about 70 μm or less, or in ranges of about 5 μm to about 15 μm, about 10 μm to about 20 μm, about 15 μm to about 25 μm, about 20 μm to about 30 μm, about 25 μm to about 35 μm, about 30 μm to about 40 μm, about 35 μm to about 45 μm, about 40 μm to about 50 μm, about 45 μm to about 60 μm, about 50 μm to about 70 μm, about 60 μm to about 80 μm, about 70 μm to about 90 μm, or about 80 μm to about 100 μm.

In some examples, the pitch or pitch resin can include an isotropic pitch. Isotropic pitch is amorphous, and the carbon fiber produced therefrom is low in strength, so anisotropic pitch is mainly used for producing high strength and high elastic carbon fiber. Physical properties and composition of isotropic pitch are important for producing high strength and high elastic carbon fibers. In particular, high-strength carbon fibers may be manufactured by melting the isotropic pitch for producing carbon fibers having a certain range and level of molecular weight, softening point and viscosity.

In some examples, the method 100 can include an act 106 that includes sorting the rare earth element. REEs with atomic numbers 57 to 63 are considered light REEs (LREEs) while those with atomic numbers 64 to 71 are considered heavy REEs (HREEs). The difficulty of separating and purifying the rare earth elements makes their production very expensive. For the rare earth elements the outermost electron shell is filled the same way, causing these elements to react in similar ways. The similar reactivity makes it difficult to separate them from one another. In some examples, act 106 can include a solvent extraction. Solvent extracting can include mixing various acids that have affinities different rare earth elements and then allowing these mixtures to settle to gradually achieve higher concentrations of specific REE metals in each separation. In some examples, the solvent extraction can achieve purities higher than 99.9%. In some examples, ligands can be used to separate the REEs. In other examples, ion exchange and precipitation can be used for recovery of REEs from pregnant leach solutions obtained from acid leaching.

In some examples, the method 100 can include the act 108 of refining the pitch or pitch resin to produce a mesophase pitch. In some examples, the method includes thermally treating the coal tar pitch to a liquid crystal phase exhibiting anisotropic spheres of a mesophase pitch. Mesophase pitch has a heterogeneous structure consisting of anisotropic regions. Several spinning modes such as centrifugal spinning, jet spinning, and conventional melt spinning have been used to spin mesophase pitches. Mesophase pitch is a precursor to mid and high performance carbon fibers, highly conductive carbon foams and other advanced carbon materials. Large highly aromatic molecules stack to form liquid crystalline domains which can be aligned by different processing methods to produce highly ordered crystalline materials with high strength and modulus with efficient electrical and thermal conductivity. In some examples, the act 108 can include a hydrogenation to make mesophase pitch. In other examples, mesophase pitch can be prepared with sulfur as crosslinking agent. The effect of crosslinking agent depends on the swelling degree of SBS (i.e., Antimony Sulfur) to some extent. Due to the cross-linking reaction, a cross-linked polymer network can be formed in mesophase pitch.

In some examples, the method 100 can include the act 110 of subjecting the mesophase pitch or pitch resin to a low-crystallinity spinning process to form a carbon fiber. The post-treatment conditions and structure of mesophase pitch determine the performance and structure of the prepared carbon materials which includes carbon fibers. In addition to its low density, high modulus, high strength, carbon fiber also has the resistance to deformation and high temperature, small coefficient of thermal expansion, good mechanical properties as well as thermal and electrical conductivity. Carbon fiber materials can be used as both structural and functional materials. High-performance carbon fiber bears high specific modulus and strength. The density of high-quality carbon fiber is only about 25% of that of steel wire while the tensile strength can reach 3 times that of steel wire, and the tensile modulus can even reach 5 times that of steel wire, which is the best material among high-performance fiber materials.

After the desired mesophase pitch has been prepared, it is spun into fibers by conventional techniques, e.g., by melt spinning, centrifugal spinning, blow spinning, or in any other known manner. As noted above, in order to obtain highly oriented carbonaceous fibers capable of being heat treated to produce carbon fibers having a high Young's modulus of elasticity and high tensile strength, the pitch must, under quiescent conditions, form a homogeneous bulk mesophase having large coalesced domains, and be nonthixotropic under the conditions employed in the spinning.

The temperature at which the pitch is spun depends of course, upon the temperature at which the pitch exhibits a suitable viscosity. Pitches containing a mesophase content of about 40 percent by weight can have a viscosity of about 200 poises at about 300° C. and about 10 poises at about 375° C., while pitches containing a mesophase content of about 90 percent by weight exhibit similar viscosities at temperatures above 430° C. Within this viscosity range, fibers can be spun from the pitch. Preferably, the pitch can have a mesophase content of from about 50 percent by weight to about 65 percent by weight and exhibits a viscosity of from about 30 poises to about 150 poises at temperatures of from about 340° C. to about 380° C. At such viscosity and temperature, uniform fibers having diameters of from about 5 microns to about 25 microns can be spun.

In some examples, the method 100 can include an act 112 of modifying a carbon fiber filter to bind or electrostatically interact with a rare earth element. For example, modifying the carbon fiber to bind or electrostatically interact with the rare earth element can include attaching a mineral binding protein or a lanthanide binding protein to the carbon fiber. For example, methylotrophic bacteria can utilize lanthanides for binding REEs. Lanmodulin or LanM includes 3 binding sites. LanM forms highly stable and water-soluble complexes across the REE series while retaining a selectivity against non-REE elements. LanM enables a one-step, quantitative extraction and purification of REEs from a pitch feedstock, including precombustion coal. In some examples, the similarity in affinity between REEs can be leveraged to recover total and multiple types of REEs against non-REE elements. In some examples, other proteins such as Tf, Scn, and CaM can also exhibit affinities toward REEs and could also be used for REE separation.

In some examples, the act 112 of modifying the carbon fiber to bind or electrostatically interact with the rare earth element can include increasing a negative charge of the carbon fiber to increase an electrostatic interaction with the rare earth element. In some examples, the carbon fiber can be functionalized to introduce magnetic or electric field properties, such as magnetite (Fe₃O₄) into the fiber with the purpose of affording magnetic properties to the material, or chitosan to increase the maximum adsorption capacity of the material. In some examples, the functionalizations can be achieved through the preparation of nanostructured silica-coated magnetite, followed by coating with the proposed functions. The resulting material tends to display higher sorption capacity of REEs and magnetic properties that simplify the separation process of the material in aqueous media.

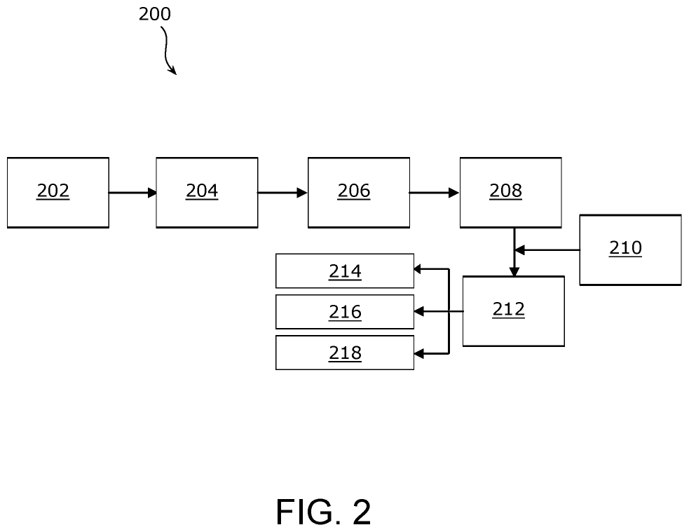

FIG. 2 is a flow chart of a system 200 for separating a rare earth element from coal and clay ores, according to an embodiment. In some examples, the system 200 includes a mine or source 202 where coal and clay ores are collected. Coal and coal by-products-including coal ash from power generation, refuse rock from coal preparation plants, acid mine drainage treatment sludge, and young lignitic coal from areas such as Wyoming can include high concentrations of rare earths that can be mined. Certain types of coal have fairly high concentrations of rare earths, on the order of hundreds of ppm. Other coal deposits can have rare-earth concentrations that reach the low thousands of parts per million. Combustion has the effect of concentrating rare earths in the ash by a factor of six to 10 relative to coal, as such coal ash is another source for the system 200.

The coal for the source 202 can then be sized for processing in a crusher 204. In some examples, the ore crusher pulverizes a raw ore into an ore particle. In some examples, the system 200 can include an ore crusher that pulverizes a raw ore into an ore particle comprising a diameter between about 1 mm and about 1 cm. In some examples, these particles can be crushed to include diameters less than 1 mm. In other examples, the particles can include diameters less than 1 μm, less than 10 μm, less than 50 μm, less than 200 μm, or less than 600 μm. In some examples the particles crushed can include a particle size in ranges between about 1 μm inch and about 1 mm. Other ranges can include between about 1 μm and about 10 μm, between about 10 μm and about 50 μm, between about 50 μm and about 250 μm, between about 250 μm and about 500 μm, between about 500 μm and about 1 mm, between about 1 mm and about 200 mm, between about 200 mm and about 500 mm, or between about 500 mm and about 1 cm.

In some examples, after sizing, water can be removed from the coal or clay ores in a dewatering system 206. Dewatering methods include both mechanical dewatering and geotube dewatering. In mechanical dewatering, crushed ore having a high water content is sent to a mechanical dewatering unit 206 (e.g., a centrifuge, a belt press, or a filter press), dewatered, and the filtered coal (filter cake) is further processed for impurity removal.

Geotube dewatering uses geotubes for dewatering. Geotubes are large filter bags made of geotextile. The crushed ore or clay can be put into a geotube and the water is allowed to drain, leaving solids in the geotube. After the geotube is filled with ore or clay, it is allowed to drain for some time. When the geotube collapses as water is drained, more ore or clay can be pumped into the geotube. After cycles of filling and draining, the geotube is filled. The ore or clay can be dewatered further, if desired, by evaporative drying for several weeks. The dewatered ore can be further processed for impurity removal.

The system 200 further includes a detection and impurity removal system 208. In some examples, filtering the ore can include removing impurities and water to physically sort and detect the rare earth element. Crystallization can be used as a purification technique if impurities are present in very small quantities, or if the impurities have a very different solubility profile from the desired compound. Impurities can be easily removed if they are either more soluble or less soluble in the dewatered ore or clay than the REEs. In some examples, the coal can be beneficiated.

The beneficiation process can include heating the coal ore to one or more desired temperatures. The one or more desired temperature can be about 100° C. to about 500° C., such as in ranges of about 100° C. to about 290° C., 100° C. to about 150° C., about 125° C. to about 200° C., or about 150° C. to about 290° C. The temperature that the ore is heated to can be selected to selectively remove at least some of at least one of the impurities that are present in the ore. For example, the ore can be heated to a temperature of about 100° C. to about 150° C. to remove moisture from the coal and about 150° C. to about 290° C. to remove volatile metals from the raw coal. In some cases, the beneficiation process can comprise heating the ore to a first desired temperature. Heating the ore to the first desired temperature can remove one or more first impurities. In some embodiments, beneficiation can then include heating the ore to a second, higher desired temperature. Heating the ore to the second desired temperature can remove one or more second impurities.

The beneficiation process can include heating the ore to the desired temperature for a desired duration. The desired duration can be about 1 second to several days, such as in ranges of about 1 second to about 1 minute, about 30 seconds to about 30 minutes, about 1 minute to about 1 hour, about 30 minutes to about 3 hours, about 1 hours to about 5 hours, about 3 hours to about 10 hours, about 7 hours to about 18 hours, about 12 hours to about 1 day, or about 18 hours to about 3 days. Typically, increasing the duration that the ore is heated to the desired temperature can increase the amount of the one or more impurities are removed from the ore. However, the ore can exhibit a maximum duration where heating the ore for periods of time longer than the maximum duration will have little or no effect on the amount of the one or more impurities that are removed from the ore. In some cases, the beneficiation process can comprise heating the ore to a first desired temperature for a first duration followed by heating the ore to a second, higher desired temperature for a second duration. The first and second durations can be the same or different.

In some examples, further processing of the ore after impurity removal and/or beneficiating the coal can include subjecting the beneficiated coal to a liquid extraction process, such as a pyrolysis process (e.g., a high temperature pyrolysis process or a mild temperature pyrolysis process). It is noted that other liquefaction processes can be used instead of or in conjunction with the pyrolysis process, such as using a direct liquefaction process or an indirect liquefaction process, membranes, an electric arc process, a super critical solvent extraction process, or an electromagnetic heating process. The liquid extraction process can convert the beneficiated coal into a pitch.

After the impurity removal system 208, the pitch can be rehydrated with a hydrating system 210. Coal ore pitch can be rehydrated to 6% to 8% moisture to avoid spontaneous combustion. After the impurity removal system 208, the ore can then be sorted with an ore sorting system 212. Physical sorting with sensor detection systems 212 can be configured to separate heavy REEs 214 and light REE 216 ores, and other metals/elements 218 that can be separated at this stage.

As described above, the heavy REEs 214 and light REEs 216 can be separated in the sorting system 212 that includes a solvent extraction. Solvent extracting can include mixing various acids that have affinities different rare earth elements and then allowing these mixtures to settle to gradually achieve higher concentrations of specific REE metals in each separation. In some examples, the solvent extraction can achieve purities higher than 99.9%. In some examples, ligands can be used to separate the REEs. In other examples, ion exchange and precipitation can be used for recovery of REEs from pregnant leach solutions obtained from acid leaching. However, other methods of extracting REEs can be utilized.

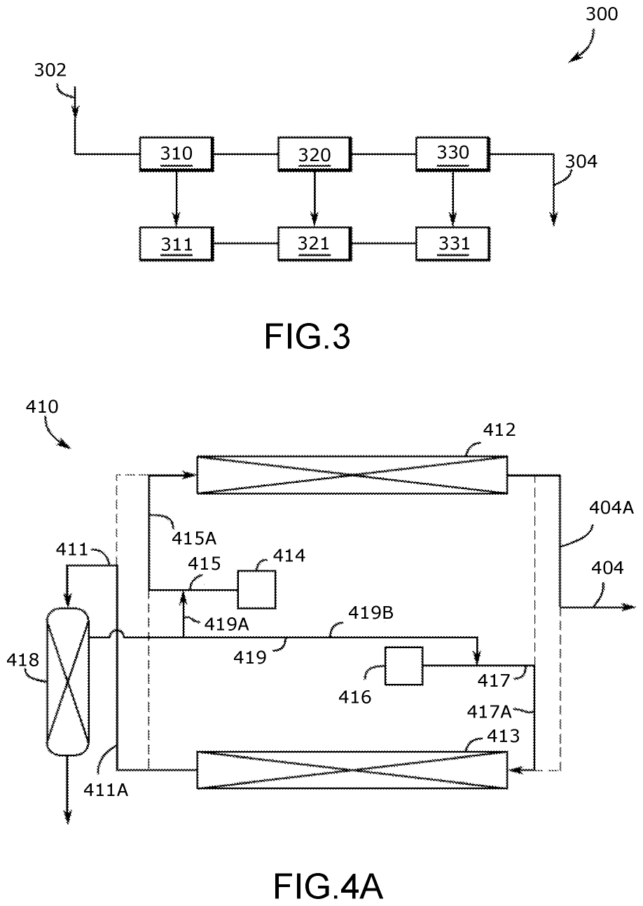

In some examples, extracting a rare earth element from a coal deposit utilizing an electrothermal swing adsorption system. FIG. 3 illustrates a schematic of an electrothermal swing adsorption system 300 with a plurality of electrothermal swing adsorption apparatuses according to one embodiment of the present disclosure.

FIG. 3 illustrates an electrothermal swing adsorption system 300 for capturing REEs from a pitch accordingly to one embodiment of the present disclosure. The electrothermal swing adsorption system 300 comprises a pitch input flow stream 302, the input flow stream including a high concentration of REEs and a filtered pitch output flow stream 304 of a lower concentration of REEs that were filtered from the pitch during swing absorption process of the electrothermal swing adsorption system 300. The term filtered does not necessarily mean the entirely free of REEs, but means that the concentration of REEs in the pitch is reduced. The pitch input flow stream 302 may include any type of REEs including at least one of gallium, germanium, cerium, lanthanum, neodymium, praseodymium, scandium, yttrium, dysprosium, terbium, samarium, ytterbium, europium, promethium, gadolinium, holmium, lutetium, thulium, or erbium.

The electrothermal swing adsorption system 300 may include a plurality of electrothermal swing adsorption apparatuses 310, 320, 330 that are arranged in series. The illustrated embodiment illustrates a first electrothermal swing adsorption apparatus 310, a second electrothermal swing adsorption apparatus 320, and a third electrothermal swing adsorption apparatus 330. In other words, the pitch input flow stream 302 is filtered by the first electrothermal swing adsorption apparatus 310, then is filtered again by the second electrothermal swing adsorption apparatus 320, and then is again by the third electrothermal swing adsorption apparatus 330. However, the present disclosure is not so limited, and the electrothermal swing adsorption system 300 may comprise more or less than three electrothermal swing adsorption apparatuses to purify the pitch input flow stream 302.

In some embodiments, the electrothermal swing adsorption apparatuses 310, 320, 330, of the electrothermal swing adsorption system 300 may be arranged in parallel. In other words, the electrothermal swing adsorption apparatuses 310, 320, 330 may filter the pitch input flow stream 302 simultaneously to increase the rate in which the REEs are removed from the pitch input flow stream 302.

Each electrothermal swing adsorption apparatus 310, 320, 330 may be functionalized for the capture of a specific REE. For example, the first electrothermal swing adsorption apparatus 310 may be functionalized to remove gallium from the pitch input flow stream 302, the second electrothermal swing adsorption apparatus 320 may be functionalized to remove germanium from the pitch input flow stream 302 after the first electrothermal swing adsorption apparatus 310 removed gallium, and the third electrothermal swing adsorption apparatus 330 may be functionalized to remove lanthanum from the pitch input flow stream 302 after the first electrothermal swing adsorption apparatus 310 and the second electrothermal swing adsorption apparatus 320 removed gallium and germanium. The result is that the pitch output flow stream 304 is free of REEs. The electrothermal swing adsorption system 300 may include additional electrothermal swing adsorption apparatuses to remove other specific REEs from the pitch input flow stream 302. For example, a fourth electrothermal swing adsorption apparatus may be functionalized to remove an REE from the pitch input flow stream 302 after the first electrothermal swing adsorption apparatus 310, the second electrothermal swing adsorption apparatus 320, and the third electrothermal swing adsorption apparatus 330 removed their intended REEs, respectively.

In some examples, the electrothermal swing adsorption apparatus 310, 320, 330 may include an active carbon monolith for adsorbing REEs explained in greater detail below. A first REE concentrated pitch stream 311 may transfer or output the pitch inlet stream 302 to a first temporary storage container for storing the concentrated REE pitch. A second concentrated pitch stream 321 may transfer or output the pitch inlet stream 302 to a second temporary storage container for storing the concentrated REE pitch. A third concentrated pitch stream 331 may transfer or output the pitch inlet stream 302 to a third temporary storage container for storing the concentrated REE pitch. In some examples, the first, second, and third temporary storage containers are different temporary storage containers that store a specific REEs. In some embodiments, the first, second, and third temporary storage containers is the same temporary storage container that stores all of the different REEs from the pitch.

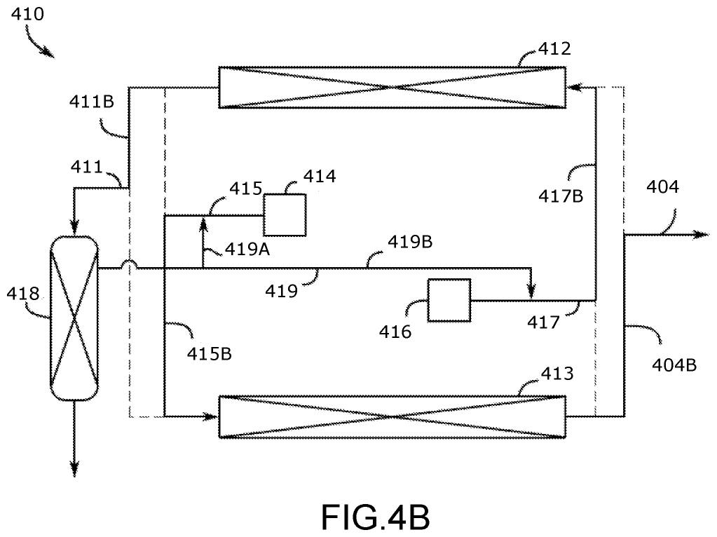

FIG. 4A illustrates a schematic of the electrothermal swing adsorption apparatus 410 in a first configuration. The first electrothermal swing adsorption apparatus 410 includes a first chamber 412 and a second chamber 413. The first chamber 412 and the second chamber 413 each house at least one carbon monolith. In some embodiments, the first chamber 412 and the second chamber 413 each only house a single carbon monolith. In some embodiments, the first chamber 412 and the second chamber 413 may each house multiple carbon monoliths.

In the illustrated embodiment, the first chamber 412 includes an active carbon monolith for adsorbing REEs and the second chamber 413 includes a regenerating carbon monolith for desorbing captured REEs from the regenerating carbon monolith. The regenerating carbon monolith in the second chamber 413 had previously adsorbed REEs. In some embodiments, the carbon monolith in the second chamber 413 has not yet adsorbed REEs when it is first placed in the second chamber 413. The first chamber 412 and the second chamber 413 operate in a cyclical fashion to perform continuous adsorption and desorption of REEs.

The carbon monoliths of the first chamber 412 and the second chamber 413 each comprises coal-based activated carbon fibers. The coal-based activated carbon fibers are procured from a coal feedstock, which allows them to be 50% to 75% more economical than existing fibers on the market produced from polyacrylonitril (PAN), rayon, and petroleum pitch precursors. The carbon fiber can be produced by melt blowing isotropic pitch derived from sub-bituminous carbon ore by the direct coal liquefaction process.

The carbon monoliths and the coal-based activated carbon fibers may be functionalized for the adsorption of a specific REE. Properties of the activated carbon fibers may be tailored so that selective adsorption is achieved. Properties of the activated carbon fibers may include pore diameter, pore size distribution, Brunauer-Emmett-Teller (BET) surface area, thermal conductivity, magnetism, bulk density, permeability, and electrical resistance. In some examples, functionalizing can include binding proteins or perhaps releasing in response to varying electrical charges. The carbon monolith of the first chamber 412 and the carbon monolith of the second chamber 413 may be similar so each carbon monolith targets the same specific REE, in some examples.

For example, the bulk density of the carbon monoliths can be greater than about 0.05 g/cm³. In some examples, the bulk density of the carbon monolith can be within a range from about 0.05 g/cm³ to about 0.7 g/cm³. In some examples, the fiber areal weight range can include a bulk density less than about 0.7 g/cm³. In other examples, the bulk density can be less than 0.6 g/cm³, less than 0.5 g/cm³, or less than 0.1 g/cm³. In some examples the bulk density of the carbon monoliths can be in ranges between about 0.05 g/cm³ and about 0.2 g/cm³. Other ranges can include between about 0.2 g/cm³ and about 0.4 g/cm³, between about 0.4 g/cm³ and about 0.5 g/cm³, between about 0.5 g/cm³ and about 0.6 g/cm³, or between about 0.6 g/cm³ and about 0.7 g/cm³. In some examples, the bulk density can be adjusted by adjusting the temperature rate while forming the carbon fiber monolith, but can also be adjusted by adjusting the airflow or oxygen concentration while forming the carbon fiber monolith.

In some examples, the permeability of the carbon monoliths can vary based primarily on the bulk density. In some examples, the permeability can also be affected by the fiber spacing and degree of melting at the nodes while forming the carbon fiber monoliths. In some examples, the permeability of the carbon monolith can be within a range from about 1×10⁻¹⁰ m² to about 8.5×10⁻¹¹ m². In some examples, the permeability range can be less than about 9.8×10⁻¹¹ m². In other examples, the permeability can be less than about 9.5×10⁻¹¹ m², less than about 9.0×10⁻¹¹ m², or less than about 8.8×10⁻¹¹ m². In some examples the permeability of the carbon monoliths can be in ranges between about 1×10-10 m² and about 9.8×10⁻¹¹ m². Other ranges can include between about 9.8×10⁻¹¹ m² and about 9.5×10⁻¹¹ m², between about 9.5×10⁻¹¹ m² and about 9.3×10⁻¹¹ m², between about 9.3×10⁻¹¹ m² and about 9×10⁻¹¹ m², between about 9×10⁻¹¹ m² and about 8.8×10⁻¹¹ m², or between about 8.8×10⁻¹¹ m² and about 8.5×10⁻¹¹ m² The intrinsic permeability of a porous medium, such as a carbon monolith, measures its ability of letting a fluid pass through it under the influence of a pressure gradient. For practical applications, it is of high interest to predict the permeability of a given medium based on its porous structure.

Furthermore, properties of the activated carbon fibers can also be tailored to decrease the temperature and energy needed to desorb the REEs from the carbon monolith. As discussed in further detail below, an electric current can be applied to the carbon monolith to induce heat by electrical resistance of the carbon fibers in the carbon monoliths and increase their temperature to aid in the desorption process to remove the REEs from the regenerating carbon monolith.

The first electrothermal swing adsorption apparatus 410 includes a pitch feed 414. The pitch feed 414 may be the same as the pitch input flow stream 302. The pitch feed 414 includes REEs disposed in the pitch. The pitch feed 414 may include a variety of different REEs.

The pitch feed 414 follows a feed flow path 415 that includes a first pitch feed flow path 415A. The pitch feed flow path 415 is introduced or received into the first chamber 412 via the first pitch feed flow path 415A. The REEs are adsorbed by the active carbon monolith in the first chamber 412 thereby filtering the pitch feed 414. The first chamber 412 is coupled to the pitch output flow stream 404 so that the pitch feed 414 can exit the first chamber 412 via the first pitch output flow stream 404A. The pitch output flow stream 404, 404A includes a lower concentration of REEs as they were desorbed by the active carbon monolith in the first chamber 412. In some embodiments, the pitch output flow stream 404, 404A can be free of the specific REE that the carbon monolith in the first chamber 412 was functionalized for and may include additional REEs that will be removed by subsequent electrothermal swing adsorption apparatuses (e.g., 320, 330) that are disposed later in series of the pitch input flow stream 302 of the electrothermal swing adsorption system 300. As discussed above, the pitch output flow stream 404, 404A may then be introduced into the second electrothermal swing adsorption apparatus 320 and then the third electrothermal swing adsorption apparatus 330. After the pitch feed 414 is outputted from all of the electrothermal swing adsorption apparatuses, the electrothermal swing adsorption system 410 can filter the REEs at a significant rate.

The first electrothermal swing adsorption apparatus 410 further includes a purge 416. The purge 416 is a reservoir of purge fluid that can be used in the desorption of the REEs from the carbon monolith in the second chamber 413. In some embodiments, a purge gas is used in the desorption process. The purge 416 follows a purge flow path 417 that includes a first purge flow path 417A. The purge 416 is introduced or received into the second chamber 413 via the first purge flow path 417A. The REEs are desorbed from the regenerating carbon monolith in the second chamber 413. The regeneration of the regenerating carbon monolith in the second chamber 413 is performed by applying an electric current to the regenerating carbon monolith to induce heat by electrical resistance of carbon monolith and increase the temperature of the carbon monolith to between 100° and 150° C. depending on the properties of the carbon monolith in the second chamber 413, the captured REEs being desorbed from the carbon monolith, and any chemical modifications of the carbon monolith. In some embodiments, the purge fluid is drained from the chamber before applying the electric current through the carbon monolith. The REEs are desorbed from the carbon monolith and into the purge 416. The REEs can be outputted out of the second chamber 413 through the concentrated pitch flow stream 411 via a first pitch flow stream 411A.

The pitch flow stream 411 may be coupled to a temporary storage container 418 that collects and stores the REEs from the first electrothermal swing adsorption apparatus 410, specifically the first chamber 412. As discussed above, the temporary storage container 418 may collect and store a specific REE that was adsorbed by the carbon monoliths in the first electrothermal swing adsorption apparatus 410. In some embodiments, the temporary storage container 418 may include a flow path 419 that is in fluid communication with the pitch feed flow path 415 via a first flow path 419A and is in fluid communication with the purge flow path 417 via a second flow path 419B.

The first electrothermal swing adsorption apparatus 410 operates in a continuous and cyclical manner. In other words, the pitch feed 414 (e.g. pitch input flow stream 302) is continuously introduced into the first chamber 412 to adsorb the REEs from the pitch feed 414 and the purge 416 is continuously introduced into the second chamber 413 to desorb the REEs from the carbon monolith in the second chamber 413. When the active carbon monolith in the first chamber 412 begins to reach a predetermined concentration/adsorption capacity (e.g., in other words, the carbon monolith cannot adsorb more REEs), the first electrothermal swing adsorption apparatus 410 can be reversed. In other words, the carbon monolith in the first chamber 412 can be regenerated by desorbing the REEs from the carbon monolith using the purge 416 and the carbon monolith in the second chamber 413 can be activated by adsorbing REEs from the pitch feed 414. Accordingly, the first electrothermal swing adsorption apparatus 410 continuously adsorbs and desorbs REEs using the carbon monoliths in the first chamber 412 and the second chamber 413.

FIG. 4B illustrates a schematic of the first electrothermal swing adsorption apparatus 410 in a second configuration. The second configuration of the first electrothermal swing adsorption apparatus 410 is reversed from the first configuration of the first electrothermal swing adsorption apparatus 410. While FIG. 4B illustrates a schematic of the first electrothermal swing adsorption apparatus 410 in the second configuration, the electrothermal swing adsorption apparatuses 320, 330 in the second configuration are similar to the schematic of the first electrothermal swing adsorption apparatus 410 in the second configuration.

The first electrothermal swing adsorption apparatus 410 in the second configuration includes the first chamber 412 and the second chamber 413. In the illustrated embodiment of the second configuration of the first electrothermal swing adsorption apparatus 410, the first chamber 412 includes a regenerating carbon monolith for desorbing REEs and the second chamber 413 includes an active carbon monolith for adsorbing REEs. Previously, the regenerating carbon monolith of the first chamber 412 was the active carbon monolith of the first chamber 412 in the first configuration and the active carbon monolith of the second chamber 413 was the regenerating carbon monolith of the second chamber 413 in the first configuration. The first chamber 412 and the second chamber 413 operate in a cyclical fashion in this manner to perform continuous adsorption and desorption of REEs.

The first electrothermal swing adsorption apparatus 410 includes the pitch feed 414. The pitch feed 414 may be the same as the pitch input flow stream 102. The pitch feed 414 includes REEs disposed in the coal pitch.

The pitch feed 414 follows a pitch feed flow path 415 that includes a second pitch feed flow path 415B. The pitch feed flow path 415 is introduced or received into the second chamber 413 via the second pitch feed flow path 415B. The REEs are adsorbed by the active carbon monolith in the second chamber 413 thereby filtering the pitch feed 414. The active carbon monolith in the second chamber 413 was the previous regenerating carbon monolith in the second chamber 413 in the first configuration. The second chamber 413 is coupled to the pitch output flow stream 404 so that the pitch feed 414 exits the second chamber 413. The pitch output flow stream 404 includes a lower concentration of REEs or can be free of REEs as they were desorbed by the active carbon monolith in the second chamber 413. In some embodiments, the pitch output flow stream 404, 404A is free of the specific REE that the carbon monolith in the first chamber 412 was functionalized for and may include additional REEs that will be removed by subsequent electrothermal swing adsorption apparatuses (e.g., 320, 330) that are disposed later in series of the electric swing adsorption system 300. As discussed above, the pitch output flow stream 404 may then be introduced or received into the second electrothermal swing adsorption apparatus 320 and then the third electrothermal swing adsorption apparatus 330. As discussed above, after the pitch feed 414 can achieve significant reduction of REEs.

The regeneration of the regenerating carbon monolith in the first chamber 412 is performed by applying an electric current to the regenerating carbon monolith to induce heat by electrical resistance of the carbon monolith and increase the temperature of the carbon monolith to between 100° and 150° C. depending on the properties of the carbon monolith in the first chamber 112, the REEs being desorbed from the carbon monolith, and any chemical modifications of the carbon monolith. In some embodiments, the purge fluid is drained from the chamber before applying the electric current through the carbon monolith. The REEs are desorbed from the carbon monolith. The concentrated REEs in the purge 416 may be transferred out of the first chamber 412 through the concentrated pitch flow stream 411 via a second concentrated pitch flow stream 411B.

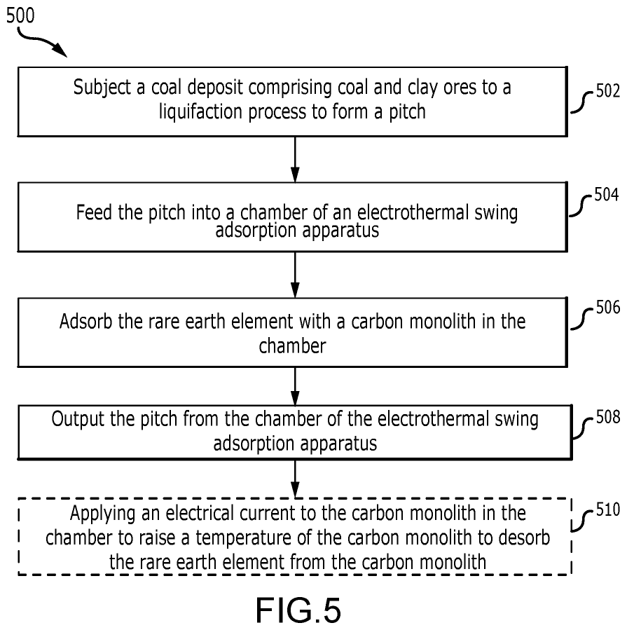

FIG. 5 is a flow chart of a method 500 of extracting a rare earth element from a coal deposit utilizing an electrothermal swing adsorption system. In some examples, the method 500 can include an act 502 of subjecting a coal deposit comprising coal and clay ores to a liquefaction process to form a pitch. The liquefaction can include a direct coal liquefaction (DCL) that involves contacting coal directly with a catalyst at elevated temperatures and pressures with added hydrogen (H₂), in the presence of a solvent to form a raw liquid product which can be filtered or processed to extract the REE and further refined into products such as liquid fuels. The latter two-step approach, i.e. the coal-to-syngas-to-liquids route is termed indirect coal liquefaction (ICL). In some examples, the liquefaction process can include crushing the coal deposit and suspending coal solids in a fluid having between about 6% and about 8% moisture. In an example, the crushed coal deposit can include a particle diameter of between about 0.5 microns and about 50 microns. However, other sizes may be used depending on the liquefaction process and the functionalization of the carbon fiber.

In some examples, the method 500 includes the act 504 of feeding the pitch into a chamber of an electrothermal swing adsorption apparatus. The pitch can include a relatively low concentration of REEs. In some examples, the pitch can include a concentration of REEs at about 400 ppm. The method 500 can further include the act 506 of adsorbing the rare earth element with a carbon monolith in the chamber. The carbon monolith comprises a coal-based activated carbon fiber. The carbon monolith can act as a filter and/or be functionalized to absorb REEs or a specific REE. In some examples, adsorbing the rare earth element with a carbon monolith in the chamber comprises moving the carbon monolith through the pitch.

In some examples, the method 500 can include an act 508 of outputting the pitch from the chamber of the electrothermal swing adsorption apparatus. The pitch can exhibit a lower concentration of REEs. In some examples, the method 500 can further include an act 510 that includes applying an electrical current to the carbon monolith in the chamber to raise a temperature of the carbon monolith to desorb the rare earth element from the carbon monolith. In some examples, after desorption, the pitch can include a concentration of about 8000 ppm or greater.

As used herein, the term “about” or “substantially” refers to an allowable variance of the term modified by “about” or “substantially” by +10% or 5%. Further, the terms “less than,” “or less,” “greater than,” “more than,” or “or more” include, as an endpoint, the value that is modified by the terms “less than,” “or less,” “greater than,” “more than,” or “or more.”

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

Various embodiments have been described herein with reference to certain specific examples. However, they will be recognized by those skilled in the art that many variations are possible without departing from the scope and spirit of the embodiments disclosed herein, in that those embodiments set forth in the claims below are intended to cover all variations and modifications of the disclosure without departing from the spirit of the embodiments.

1. A method of separating a rare earth element from coal and clay ores, comprising:
subjecting a raw coal to a liquefaction process to form a pitch or a pitch resin;
filtering the pitch or pitch resin to capture the rare earth element;
refining the pitch or pitch resin to produce a mesophase pitch; and
subjecting the mesophase pitch or pitch resin to a low-crystallinity spinning process to form a carbon fiber.

2. The method of claim 1, wherein the rare earth element comprises at least one of gallium, germanium, cerium, lanthanum, neodymium, praseodymium, scandium, yttrium, dysprosium, terbium, samarium, ytterbium, europium, promethium, gadolinium, holmium, lutetium, thulium, or erbium.

3. The method of claim 1, wherein the pitch or pitch resin comprises an isotropic pitch.

4. The method of claim 1, wherein filtering the pitch or a pitch resin comprises removing impurities and water to physically sort and detect the rare earth element.

5. The method of claim 4, further comprising rehydrating the pitch or pitch resin to between about 6% and about 8% moisture.

6. The method of claim 1, further comprising sorting the rare earth element as either a heavy rare earth element or a light rare earth element.

7. The method of claim 1, further comprising modifying the carbon fiber to bind or electrostatically interact with a rare earth element.

8. The method of claim 7, wherein modifying the carbon fiber to bind or electrostatically interact with the rare earth element comprises attaching a mineral binding protein or a lanthanide binding protein to the carbon fiber.

9. The method of claim 7, wherein modifying the carbon fiber to bind or electrostatically interact with the rare earth element comprises increasing a negative charge of the carbon fiber to increase an electrostatic interaction with the rare earth element.

10. A method of extracting a rare earth element from a coal deposit utilizing an electrothermal swing adsorption system comprising:
subjecting a coal deposit comprising coal and clay ores to a liquefaction process to form a pitch;
feeding the pitch into a chamber of an electrothermal swing adsorption apparatus;
adsorbing the rare earth element with a carbon monolith in the chamber; and
outputting the pitch from the chamber of the electrothermal swing adsorption apparatus.

11. The method of claim 10, further comprising applying an electrical current to the carbon monolith in the chamber to raise a temperature of the carbon monolith to desorb the rare earth element from the carbon monolith.

12. The method of claim 10, wherein adsorbing the rare earth element with a carbon monolith in the chamber comprises moving the carbon monolith through the pitch.

13. The method of claim 10, wherein the carbon monolith comprises a coal-based activated carbon fiber.

14. The method of claim 10, wherein the liquefaction process comprises crushing the coal deposit and suspending coal solids in a fluid having between about 6% and about 8% moisture.

15. The method of claim 14, wherein the crushed coal deposit comprises a particle diameter of between about 0.5 microns and about 50 microns.

16. A system to extract a rare earth element from a coal deposit, comprising:
an electrothermal swing adsorption apparatus comprising:
a first chamber comprising at least one carbon monolith; and
a second chamber comprising at least one carbon monolith;
wherein the electrothermal swing adsorption apparatus is configured to receive a feed of a coal-based pitch with at least one rare earth element therein;
wherein each of the carbon monolith of the electrothermal swing adsorption apparatus comprises coal-based activated carbon fibers configured to capture the rare earth element.

17. The system of claim 16, wherein the at least one carbon monolith of the first chamber captures the rare earth element and the at least one carbon monolith of the second chamber desorbs the rare earth element simultaneously as the at least one carbon monolith of the first chamber releases the rare earth element.

18. The system of claim 16, wherein the first chamber and the second chamber operate in a cyclical fashion to perform continuous capture and release of rare earth elements such that capture occurs in one of the first chamber and the second chamber while release occurs in the other of the first chamber and the second chamber.

19. The system of claim 16, wherein each carbon monolith is functionalized to adsorb a specific rare earth element.

20. The system of claim 16, wherein the coal-based activated carbon fibers are melt-blown from an isotropic pitch.
